(19) United States
(12) Patent Application Publication
(10) Pub. No.: US 2009/0149146 A1
(43) Pub. Date: Jun. 11, 2009

(54) ADAPTIVE MILLIMETER-WAVE ANTENNA SYSTEM

(75) Inventors: Rudy Emrick, Gilbert, AZ (US); Bruce Bosco, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/950,873

(22) Filed: Dec. 5, 2007

(51) Int. Cl. H04B 1/18

(52) U.S. Cl. 455/277.2; 455/277.1

(57) ABSTRACT

A method of receiving an RF signal in a wireless communication device includes receiving (1002) a signal having a frequency greater than 10 gigahertz by at least two of a plurality of millimeter wave antennas (122, 124, 126, 128, 822, 824, 826, 828, 922, 924, 926, 928) positioned within the portable wireless communication device. A characteristic of the signal at each antenna (122, 124, 126, 128, 822, 824, 826, 828, 922, 924, 926, 928) is determined (1004) and at least one of the plurality of millimeter wave antennas (122, 124, 126, 128, 822, 824, 826, 828, 922, 924, 926, 928) is selected (1006) based on the characteristics. The signal from the selected millimeter wave antenna (122, 124, 126, 128, 822, 824, 826, 828, 922, 924, 926, 928) is forwarded (1008) to a device controller 104. A combination of signals from the plurality of antennas may be evaluated prior to selecting two or more of the antennas (122, 124, 126, 128, 822, 824, 826, 828, 922, 924, 926, 928).

### FIELD

The present invention generally relates to wireless communication devices and more particularly to a method and apparatus for selecting one or more millimeter-wave antennas in a wireless communication device.

### BACKGROUND

The market for personal wireless electronic devices, for example, cell phones, personal digital assistants (PDA's), digital cameras, and music playback devices (MP3), is very competitive. Manufactures are constantly improving their product with each model in an attempt to cut costs and production requirements.

Global telecommunication systems, such as cell phones and two way radios, are migrating to higher frequencies and data rates due to increased consumer demand on usage and the desire for more content. Current mobile devices are challenged by the increased functionality and complexity of multi-modes, multi-bands, and multi-standards, and progressing beyond 3G with the increasing requirement of multimedia, mobile internet, connected home solutions, sensor-network, high-speed data connectivity such as Bluetooth, RFID, WLAN, WiMAX, UWB, and 4G. Limited battery power and tight design space will become bottlenecks for the high integration and development of mobile devices. The tight design space is especially challenging for RF technologies and the requisite design/fabrication of adaptive/tunable antennas.

Known antennas ranging from macro-size to micro-size, are based on a top-down approach, and are bulky. They have difficulties in meeting performance and power-consumption requirements, particularly with increased frequency, functionality and complexity of multi-modes, multi-bands, and multi standards for seamless mobility.

However, as the frequency at which the mobile devices transmit and receive data increases, the size of antennas decreases allowing for more freedom in system design.

Accordingly, it is desirable to provide an antenna system for wireless mobile devices having improved transmission and reception. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

Embodiments of the present invention will hereinafter be described in conjunction with the following drawing figures, wherein like numerals denote like elements, and

FIG. 1 is block diagram of a known antenna system capable of utilizing exemplary embodiments;

FIG. 2 is a block diagram of exemplary embodiment;

FIG. 3 is a circuit diagram of a portion of the embodiment of FIG. 2;

FIGS. 4-9 are block diagrams illustrating various methods of exemplary embodiments; and

FIG. 10 is a flow chart of one exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Improved wireless transmission and reception in portable communication devices are provided by two or more millimeter-wave antennas within a single communication device that are adaptively selected to provide a widely directional gain. One or more antennas may be selected based on signal characteristics including, for example, strength, phase, and polarization. These can all be affected by the scattering environment in which the system is operating and are directly affected by the dimensions of the reception area, for example, a room, including contents positioning and material properties. Signal characteristics and reception may be impacted, for example, by a scattering environment, obstructions, an interfering signal, and the position of the device, e.g., how it is held. Further, these parameters can vary over time as objects such as furniture, people, and the device itself) move from one position to another or in orientation. Blockage of the line of sight path can have adverse effects on performance for shorter range wireless personal area network technologies such as Bluetooth which operates around 2.4 GHz. This blockage may even be due to the person's hand as they hold such a device, and if their grip is in close proximity to the antenna. This effect can be more pronounced as the frequency of operation is increased. In order to enable optimized performance in complex scattering environments such as indoor rooms, a plurality of antennas may be placed in various locations within a device. These antennas can have varying gain and polarization direction of orientation (the main beams of each antenna may be pointed in varying directions). By this varying placement of antennas, the signals received by the plurality of antennas can be combined so that optimum received signal to noise ratios can be achieved. This allows for combining of signals from antennas that are positioned such that they can receive reflections from alternative paths when the line of sight path is blocked. In order to further improve performance, these antennas may also adaptively configure to receive the polarization of the received signals. In addition to adapting to best receive desired signals, adaptively configuring to minimize reception of interfering or undesired signals can further improve system performance. The benefits of the adaptive antenna system can be realized for transmitting as well as receiving. The best combination of transmit antennas can be selected in order to mitigate effects of blockage or other effects of the operating environment.

Referring to FIG. 1, a block diagram of a portion of a wireless communication device 100 in accordance with an exemplary embodiment is shown. Although the wireless communication device 100 in the exemplary embodiment is preferably portable, it should be understood that in some embodiments it may be stationary, for example, in a fixed installation. The wireless communication device 100 may be any portable device that communicates using radio frequency (RF) signals and that is stationary or relatively stationary, i.e., moving slowly relative to a wavelength of the frequency at which the device is operating. Examples of the wireless communication device 100 include a cellular telephone and a local area radio transceiver. While the data transfer benefits of the wireless communication device 100 may be realized at any transmitted/received frequency, it is anticipated that a higher frequency, for example, greater than 10 GHz, would allow for small antennas that would be more suitable for the portable wireless communication devices contemplated.

A portion of the wireless communication device 100 comprises an antenna system 102 coupled bi-directionally to a device controller 104 by antenna controller input signals 106, 108. The wireless communication device 100 typically comprises other components (not shown), depending on the type of device, such as a display, keys and/or push buttons on the display, external connectors, and batteries. The device controller 104 typically includes applications such as user interface functions, location finding functions, and handoff algorithms. The antenna controller input signal 108 comprises a demodulated signal obtained from RF signals intercepted by the antenna system 102. The antenna controller input signal 106 may include an identification of an application that uses information included in the demodulated signal included in signal 108.

The antenna system 102 includes an antenna structure 112, a transceiver 114, and an antenna controller 116. In one embodiment, the antenna controller 116 is a digital signal processor, but may be any combination of processing apparatus, such as a stored program controlled microprocessor, and it may be combined with the device controller 104 or another controller in the wireless communication device 100. The antenna structure 112 includes an arrangement of antennas 118, which in some embodiment may be dual polarized antennas 122, 124, 126, 128; a switching matrix 132 to which the arrangement of antennas 118 and the antenna system controller 116 are coupled; and a combiner 134 to which the switching matrix 132 and the antenna system controller 116 are coupled. The switching matrix 132 couples a subset of the signals generated by a selected subset of the elements of the arrangement of antennas 118 to the combiner 134 and rejects signals not from the selected subset of elements. The rejection may be accomplished, for example, by grounding the rejected signal or by causing an essentially open circuit to the rejected signal. The subset is selected by a subset selection signal 136 coupled from the antenna controller system 11 6. A subset is one or more antenna elements, where two or more elements are also referred to as a combination of antenna elements.

The combiner 134 may be a non-configurable device, e.g., it may not need control signals to accomplish combining the subset of signals selected by the switching matrix 132, in which case it may not be coupled to the antenna controller 116. The switching matrix 132 and the combiner 134 may be combined into one functional component. The combiner 134 combines the signals from the selected antenna elements 122, 124, 126, 128 into a combined RF signal 138.

Each individual antenna 122, 124, 126, 128, the switching matrix 132, and the combiner 134 may be designed and fabricated using conventional or other techniques. For example, the antennas 122, 124, 126, 128 of the antenna structure 112 may be any conventional structure such as a single antenna element or arrays of antenna elements on printed circuit board materials or implemented using formed or cast metals. Each antenna 122, 124, 126, 128 has a polarization that is common. Although four antennas 122, 124, 126, 128 are shown in FIG. 1, various embodiments would include at least two antennas. The position of the antennas 122, 124, 126, 128 within the wireless communication device 100 is discussed hereinafter. The transceiver 114 is coupled to the RF signal 138 generated by the combiner 134 and generates a demodulated signal 108 that is coupled to the antenna controller 116 and the device controller 104. The antenna controller 116 uses the demodulated signal 108 to evaluate characteristics of the combined RF signal 138.

Alternatively, the functions of the switching matrix 132, the combiner 134, the transceiver 114, and even the device controller 104, and the antenna controller 116 could be preformed by a digital signal processor.

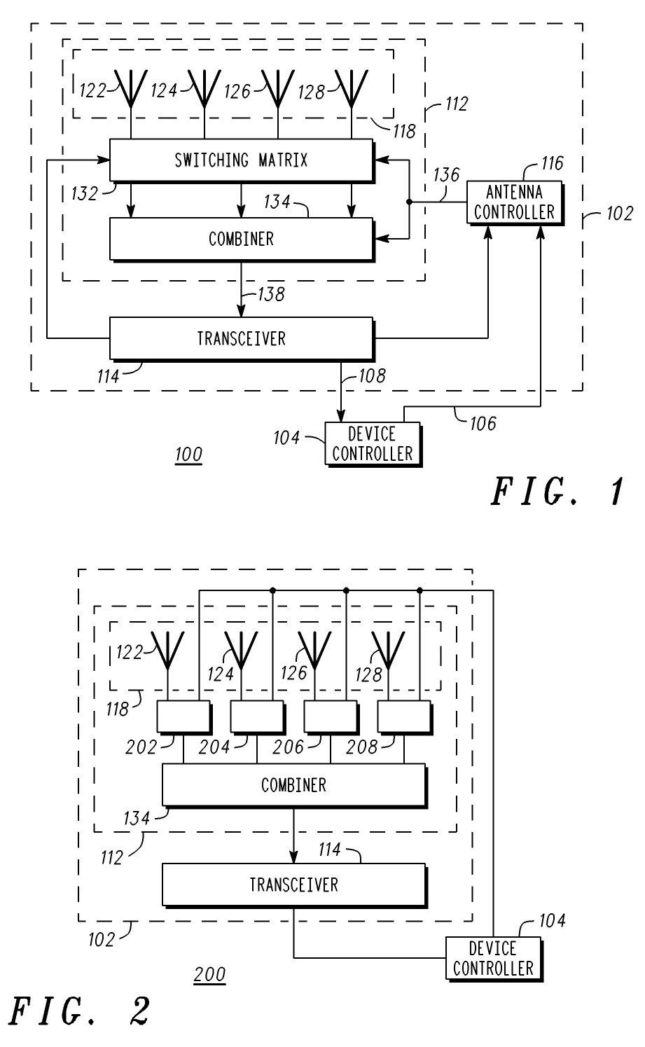

In an alternate exemplary embodiment 200 shown in FIG. 2, the switching matrix 132 and antenna controller 116 are replaced by detector circuits 202, 204, 206, 208, each coupled between the respective antenna 122, 124, 126, 128 and the combiner 134 in the device 200 (only detector circuit 202 is shown). The device controller 104 may be coupled to each of the detector circuits 202, 204, 206, 208 for enabling or disabling thereof in some exemplary embodiments. An exemplary embodiment of the detector circuit 202 (see FIG. 3) includes a coupler 209 coupled between one of the antennas 122, 124, 126, 128 and the switch 210. A detector 211 comprising a diode 212, an inductor 214, a capacitor 216, and an inductor 218 receives a sample of the signal at the coupler 204. A voltage sampler 222, including a resistor 224 and the RC time structure of resistor 226 and capacitor 228, samples the voltage at node 230 for application to the switch 206. If the voltage at node 230 is above a threshold, the switch 206 passes the signal on the antenna 202, 204, 206, 208 to the combiner. If below a threshold, the signal is diverted through resistor 232 to a low potential, e.g., ground, at node 234. This may be done to avoid combining the signals received which are low level with those that are relatively stronger. This may provide a more optimum receive signal in cases where the low level signals are received substantially out of phase (later in time) compared with the strong signals and the additional losses associated with adjusting the phases of the signals so that they can be combined properly may be greater than the potential gain of combining them.

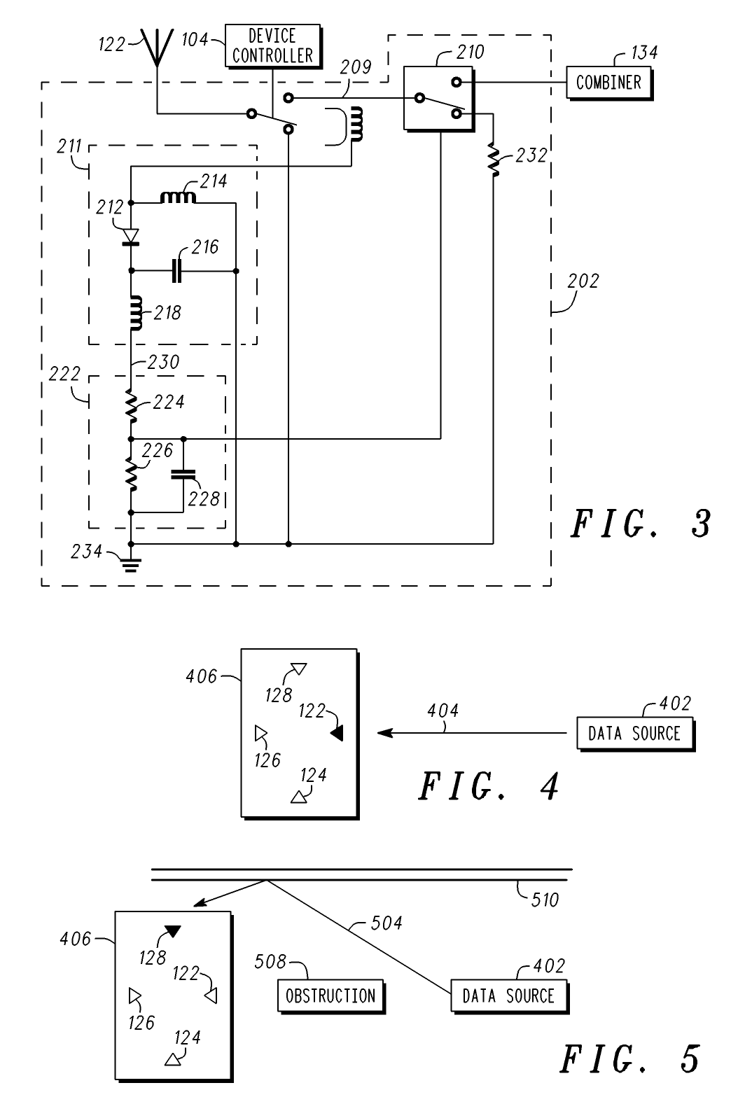

FIGS. 4-9 describe exemplary embodiments of methods utilizing the structures of FIGS. 1-3. In the exemplary embodiment of FIG. 4, a data source 402 transmits a signal 404 to the communication device 406. The antenna indicating the best reception (antenna 122 in this case and blackened for illustration) passes the signal 404 on to the combiner 134, while the other antennas 124, 126, 128 are disabled by being disconnected from the combiner 134 or grounded, for example. The exemplary embodiment of FIG. 5 illustrates a data source 502 transmitting a signal 504 to the communication device 506. However, an obstruction 508 is positioned between the data source 502 and the communication device 506 (and the antenna 122). The signal 504 reflects off a structure 510, for example a wall, and reaches the communication device 506. In this exemplary embodiment, the antenna 128 exhibits the best reception, passing the signal on to the combiner 134. The signals on antennas 122, 124, 126 are disabled.

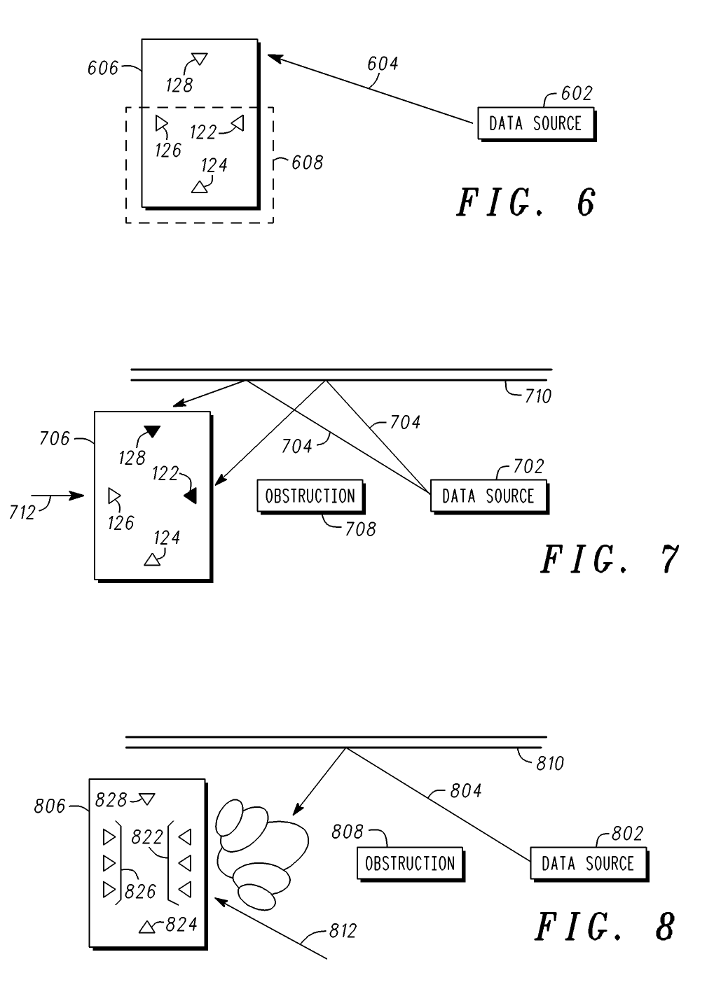

In the exemplary embodiment of FIG. 6, the data source 602 transmits a signal 604 to the communication device 606, but a portion of the user's body 608, such as a hand or a combination of body portions, such as a hand and a head, blocks the antennas 122, 124, 126, preventing sufficient reception. Therefore, the antenna 128 exhibits the best reception, and the signal is passed from antenna 128 to the combiner 134.

In the exemplary embodiment of FIG. 7, the data source 702 transmits a signal 704 that is blocked by obstruction 708 but received by antennas 122, 128 after being reflected off the structure 710. Any signal on antenna 124 is disabled since its magnitude is below the signal received by antennas 122, 128. An interfering signal 712 is received by antenna 126, but the antenna 126 is disabled. The decision to disable may be based on one of several reasons, e.g., the interfering signal 712 may lack an address component found in the signal 704.

Referring to FIG. 8, the data source 802, in this exemplary embodiment, transmits a signal 804 past the obstruction 808 and off the structure 810 to the communication device 806, while an interfering signal 812 arrives at the communication device 806. Each of the antennas 822, 824, 826, 828 is constructed to provide lobes that are tuned to receive the desired signal 804, thereby the interfering signal 812 is differentiated therefrom and rejected. This may be done by combining an array of antennas with the proper relative phase adjustment to each signal received by elements of the array so that a null in the beam is formed in the direction of the interfering signal.

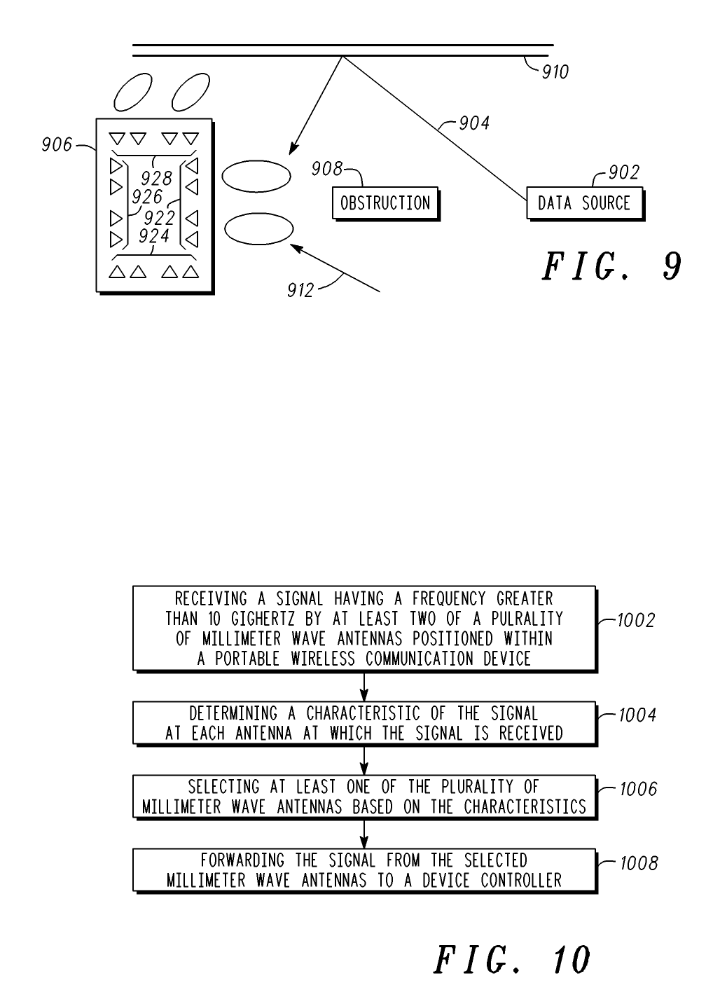

In the exemplary embodiment of FIG. 9, the data source 902 transmits a signal 904 past the obstacle 908 and off the structure 910 to the communication device 906, while an interfering signal 912 arrives at the communication device 906. The antennas 922, 924, 926, 928 are polarized to receive the signal 904 while rejecting the interfering signal 912. This can be implemented by using the methods described previously, and by polarization control at each antenna. This may be done, for example, by implementing each individual antenna element such that it can receive at least two orthogonal linear polarizations. By adjusting the phase difference between the signals received by the two orthogonal sections of the antenna before combining them, the combined signal will be substantially the same as it would be from an equivalent single polarization antenna. This type of antenna can be controlled to receive a linearly polarized signal of any orientation in addition to right or left handed circular or elliptical polarizations.

FIG. 10 is a flow chart illustrating the steps on one exemplary embodiment wherein the portable wireless communication device receives 1002 a signal having a frequency greater than 10 gigahertz by at least two of a plurality of millimeter wave antennas. A characteristic of the signal at each antenna for which the signal is received is determined 1004, and at least one of the plurality of millimeter wave antennas is selected 1006 bases on the characteristics. The signal from the selected antenna, or a combined signal from two or more of the selected antennas, is forwarded 1008 to a device controller.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of receiving an RF signal in a wireless communication device, comprising:
receiving a signal having a frequency greater than 10 gigahertz by at least two of a plurality of millimeter wave antennas positioned within the portable wireless communication device;
determining a characteristic of the signal at each antenna;
selecting at least one of the plurality of millimeter wave antennas based on the characteristics; and
forwarding the signal from the selected millimeter wave antennas to a device controller.

2. The method of claim 1 wherein the selecting step comprises selecting at least two antennas and combining the signals therefrom for forwarding to a device controller.

3. The method of claim 2 further comprising evaluating the signal from each antenna in a plurality of combinations prior to selecting step.

4. The method of claim 1 wherein the identifying step comprises determining the phase of the RF signal received at each of the plurality of antennas.

5. The method of claim 1 wherein the disabling step comprises determining whether the strength of the RF signal received is below a threshold.

6. The method of claim 1 wherein the identifying step comprises identifying antennas determined by a function of the wireless communication device selected.

7. The method of claim 1 wherein the disabling step comprises disabling an antenna when an unknown signal is received.

8. The method of claim 1 wherein the identifying step comprises identifying an antenna based on the polarization of the RF signal.

9. The method of claim 1 wherein receiving step comprises receiving the signal by tuned antennas.

10. A method of selecting at least one of a plurality of millimeter wave antennas of a wireless communication device to receive an RF signal having a frequency in the range of 60 to 80 gigahertz, comprising:
receiving the RF signal by at least two of the plurality of millimeter wave antennas;
determining a characteristic of the received RF signal at each of the plurality of millimeter wave antennas at which the RF signal is received;
identifying at least one of the plurality of millimeter wave antennas when the RF signal characteristic is above a threshold;
disabling at least one of the plurality of millimeter wave antennas when its respective RF signal characteristic is below a threshold; and
forwarding the RF signal from the identified antennas to a device controller.

11. The method of claim 10 wherein the identifying step comprises identifying at least two antennas.

12. The method of claim 11 further comprising combining the signal from the at least two antennas.

13. The method of claim 10 wherein the identifying step comprises determining the phase of the RF signal received at each of the plurality of antennas.

14. The method of claim 10 wherein the disabling step comprises determining whether the strength of the RF signal received is below a threshold.

15. The method of claim 10 wherein the identifying step comprises identifying antennas determined by a function of the wireless communication device selected.

16. The method of claim 10 wherein the disabling step comprises disabling an antenna when an unknown signal is received.

17. The method of claim 10 wherein the identifying step comprises identifying an antenna based on the polarization of the RF signal.

18. The method of claim 10 wherein receiving step comprises receiving the signal by tuned antennas.
